(19) United States
(12) Patent Application Publication
(10) Pub. No.: US 2015/0086142 A1
(43) Pub. Date: Mar. 26, 2015

(54) ROTATING DEVICE

(71) Applicant: SAMSUNG ELECTRO-MECHANICS JAPAN ADVANCED TECH. CO. LTD., Fujieda City (JP)

(72) Inventors: Takashi IKEDA, Fujieda City (JP); Hiroshi IWAI, Fujieda City (JP)

(73) Assignee: SAMSUNG ELECTRO-MECHANICS JAPAN ADVANCED TECH. CO. LTD., Fujieda City (JP)

(21) Appl. No.: 14/494,266

(22) Filed: Sep. 23, 2014

(30) Foreign Application Priority Data
Sep. 24, 2013 (JP) 2013-196820

(51) Int. Cl. G11B 19/20; F16C 33/12; F16C 17/04

(52) U.S. Cl. CPC G11B 19/2036; F16C 17/045; F16C 33/125
USPC 384/112

(57) ABSTRACT

A rotating device includes a shaft body including a portion extending in an axial direction, and a bearing body which retains a part of the shaft body, is relatively rotatable to the shaft body, and is provided with a groove formed part having an inner circumference formed with a fluid dynamic pressure generating groove. The bearing body includes, at the groove formed part, a slanted plating layer having a plating thickness gradually becoming thick toward an external side in the axial direction.

### BACKGROUND OF THE INVENTION

1. Field of the Invention

The present disclosure relates to a rotating device including a fluid dynamic bearing.

2. Description of the Related Art

Disk drive devices like hard disk drives that are a kind of rotating devices are becoming compact and increasing the capacity, and are loaded in various electronic devices. In particular, disk drive devices are now loaded in portable electronic devices, such as a laptop computer and a portable music player. The disk drive devices loaded in such portable electronic devices need to improve the shock resistance and the vibration resistance so as to withstand a shock due to falling and a vibration at the time of carriage.

For example, JP 2012-191708 A and JP 2013-055791 A disclose a disk drive device employing a fluid dynamic bearing mechanism as a bearing.

According to the conventional disk drive devices disclosed in, for example, JP 2012-191708 A and JP 2013-055791 A, dynamic pressure generating grooves are formed in grooved formed portions of a bearing body, and when a rotating device is made compact, the dimension of the groove formed part is reduced, often resulting in a reduction of the rigidity of a fluid dynamic bearing. In addition, according to the conventional disk drive devices, in order to adjust the surface hardness of the groove formed part, a plating layer is formed on the surface of the grooved formed portion after the dynamic pressure generating grooves are formed. The dynamic pressure generating grooves having undergone plating may have a rounded edge in comparison with the grooves prior to the plating, and thus the shape accuracy is deteriorated, resulting in a reduction of dynamic pressure.

Still further, according to such disk drive devices, a shaft is held by a shaft encircling portion in a tilted condition when the disk drive devices are still or rotate at a slow speed. In this case, the shaft contacts an external area of the inner circumference of the shaft encircling portion in the direction of a rotation axis, i.e., an area near an inward end. When the disk drive devices repeat activation/deactivation with the shaft being contact, the wear level of the contact portion becomes larger than other portions. Moreover, when a shock or a vibration is applied to the disk drive devices, large stress is applied to the portion of the shaft encircling portion contacting the shaft, and such a portion may be deformed. In the worst case, this causes a breakdown. In particular, when the thickness of the plating layer of the contacting portion of the shaft encircling portion is thin, the durability against the wear at the time of activation/deactivation and the shock resistance may decrease.

Such a technical problems are common to, not only the rotating devices loaded in portable electronic devices, but also the rotating devices loaded in other kinds of electronic devices, such as a stationary type electronic device.

The present disclosure has been made in view of the aforementioned circumstances, and it is an objective of the present disclosure to provide a rotating device which can improve the wear resistance of dynamic pressure generating grooves, and which can suppress a reduction of a shock resistance when downsized.

### SUMMARY OF THE INVENTION

To accomplish the above objective, a rotating device according to a first aspect of the present disclosure includes: a shaft body including a portion extending in an axial direction; and a bearing body which retains a part of the shaft body, is relatively rotatable to the shaft body, and is provided with a groove formed part having an inner circumference formed with a fluid dynamic pressure generating groove, in which the bearing body comprises, at the groove formed part, a slanted plating layer having a plating thickness gradually becoming thick toward an external side in the axial direction.

To accomplish the above objective, a rotating device according to a second aspect of the present disclosure includes: a shaft body including a portion extending in an axial direction; and a bearing body which retains a part of the shaft body, is relatively rotatable to the shaft body, and is provided with a groove formed part having an inner circumference formed with a fluid dynamic pressure generating groove, in which the bearing body comprises, at the groove formed part, a slanted plating layer having a plating thickness gradually becoming thick toward an internal side in the axial direction.

To accomplish the above objective, a rotating device according to a third aspect of the present disclosure includes: a shaft body including a portion extending in an axial direction; and a bearing body which retains a part of the shaft body, is relatively rotatable to the shaft body, and is provided with a groove formed part having an inner circumference formed with a fluid dynamic pressure generating groove, in which: the bearing body comprises, at the groove formed part, a slanted plating layer having a plating thickness gradually becoming thick toward a first direction in the axial direction; a difference between a maximum plating thickness of the slanted plating layer and a minimum plating thickness thereof is within a range between equal to or greater than 0.1 μm and equal to or smaller than 0.5 μm; and the fluid dynamic pressure generating groove is engraved in an external surface side of the slanted plating layer.

Any arbitrary combination of the aforementioned structural components, and mutual replacement of the subject matter with a method, a device, and a system, etc., are also effective as embodiments of the present disclosure.

### BRIEF DESCRIPTION OF THE DRAWINGS

FIG. 1 is an exploded perspective view illustrating a disk drive device that is a kind of rotating device according to an embodiment of the present disclosure;

FIG. 2 is a cross-sectional view mainly illustrating a left part of a cross section taken along a line A-A in FIG. 1;

FIG. 3 is an enlarged cross-sectional view exemplarily illustrating a shaft encircling portion of the disk drive device in FIG. 2;

FIG. 4 is an enlarged cross-sectional view exemplarily illustrating an example structure of a groove formed part of the shaft encircling portion of the disk drive device; and

FIG. 5 is an enlarged cross-sectional view exemplarily illustrating a structure of another example corresponding to FIG. 4.

### DETAILED DESCRIPTION OF THE PREFERRED EMBODIMENTS

The same or corresponding structural element and component illustrated in respective figures will be denoted by the same reference numeral below, and the duplicated explanation thereof will be omitted. In addition, the dimension of the component in each figure will be enlarged or scaled-down as needed to facilitate understanding to the present invention. Still further, a part of the component not important to explain the present disclosure will be omitted in respective figures.

An embodiment relates to a disk drive device that is a kind of rotating device. The disk drive device of the embodiment is, for example, suitably applied as a hard disk drive on which a magnetic recording disk magnetically recording data is to be mounted, and which rotates and drives the magnetic recording disk.

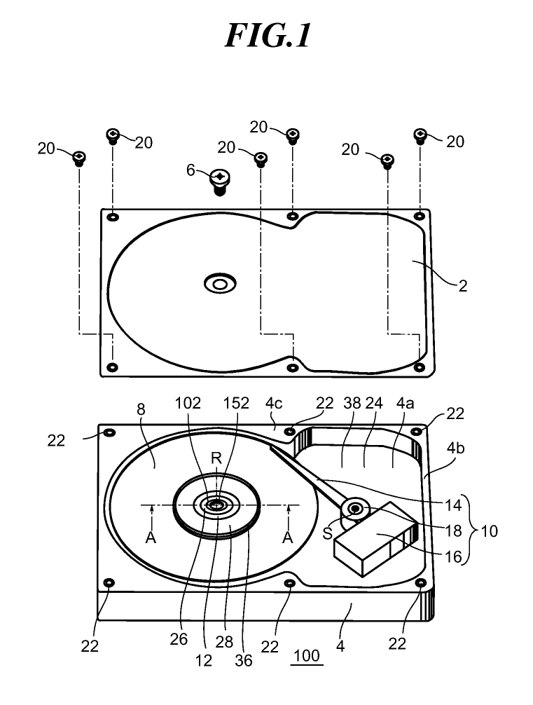

FIG. 1 is a perspective view illustrating a disk drive device 100 according to this embodiment. In FIG. 1, a top cover 2 is detached to facilitate understanding to the present disclosure. In FIG. 1, for example, an electronic circuit not important to explain the present disclosure is omitted. The disk drive device 100 includes a stationary body, a rotating body rotating relative to the stationary body, a magnetic recording disk 8 to be attached to the rotating body, and a data reader/writer 10. The stationary body includes a base 4, a shaft 26 fixed relative to the base 4, a housing 102 supporting the shaft 26, the top cover 2, six screws 20, and a shaft fastening screw 6. The rotating body includes a hub 28, a clamper 36, and a cover ring 12.

In the following explanation, a side at which the hub 28 is mounted relative to the base 4 will be defined as an upper side.

The magnetic recording disk 8 is, for example, a 2.5-inch magnetic recording disk formed of glass and having a diameter of 65 mm. The center hole has a diameter of 20 mm, and the thickness of the magnetic recording disk 8 is 0.65 mm. One magnetic recording disk 8 is to be mounted on the hub 28.

(Base)

The base 4 includes a bottom portion 4a forming the bottom of the disk drive device 100, and an outer circumference wall 4b formed along the outer circumference of the bottom portion 4a so as to encircle an area where the magnetic recording disk 8 is mounted. For example, six screw holes 22 are provided in an upper face 4c of the outer circumference wall 4B. The base 4 is formed and shaped by die-casting of, for example, an aluminum alloy. The base 4 maybe formed by pressing of a steel sheet or an aluminum sheet. A surface coating is applied to the base 4 in order to suppress a peeling from the surface thereof. An example surface coating applied is a resin-material coating like an epoxy resin. As a surface coating, instead of the resin material, a metal material, such as nickel or chrome, may be applied as coating by plating.

(Data Reader/Writer)

The data reader/writer 10 includes an unillustrated recording/playing head, a swing arm 14, a voice coil motor 16, and a pivot assembly 18. The recoding/playing head is attached to the tip of the swing arm 14, records data in the magnetic recording disk 8, or reads the data therefrom. The pivot assembly 18 supports the swing arm 14 in a swingable manner to the base 4 around a head rotating axis S. The voice coil motor 16 allows the swing arm 14 to swing around the head rotating axis S to move the recording/playing head to a desired location over the top face of the magnetic recording disk 8. The voice coil motor 16 and the pivot assembly 18 are configured by a conventionally well-known technology of controlling the position of a head.

(Top Cover)

The top cover 2 is fastened to the upper face 4c of the outer circumference wall 4b of the base 4 using, for example, six screws 20. The six screws 20 correspond to the six screw holes 22. In particular, the top cover 2 and the upper face 4c of the outer circumference wall 4b are fastened together in such a way that no leak to the interior of the disk drive device 100 occurs from the joined portion therebetween. The interior of the disk drive device 100 is, more specifically, a clean space 24 surrounded by the bottom portion 4a of the base 4, the outer circumference wall 4b thereof, and the top cover 2. This clean space 24 is designed so as to be air-tightly sealed, i.e., so as to have no leak-in from the exterior and leak-out to the exterior. The clean space 24 is filled with a clean filler gas having particles eliminated. Example filler gases are various gases including air. In this embodiment, a gas with a smaller molecular weight than nitrogen, such as helium or hydrogen, is filled in the clean space 24.

(Shaft)

The shaft 26 has the shaft fastening screw 6 passing all the way through the top cover 2, and engaged with a shaft-fastening-screw hole 152 provided in an upper end face of the shaft 26. Hence, the shaft 26 is fixed to the top cover 2. The shaft 26 is formed by, for example, cutting, machining and grinding of a ferrous material like SUS 420 J2 of stainless-steel, and a heat treatment is applied thereto in order to accomplish a desired hardness.

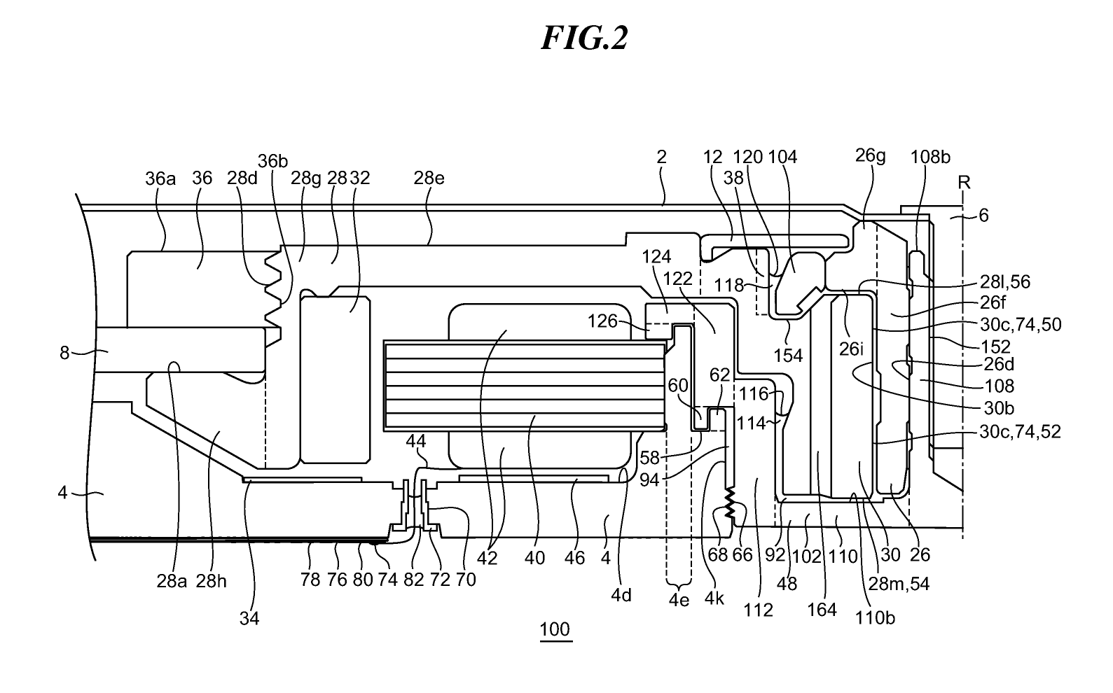

FIG. 2 is a cross-sectional view mainly illustrating the left part of the cross section taken along a line A-A in FIG. 1. The cross section illustrated in FIG. 2 corresponds to a half cross section of a motor component in the disk drive device 100.

The rotating body includes the hub 28, the clamper 36, a magnet 32, and the cover ring 12. The stationary body includes the base 4, a stator core 40, coils 42, the housing 102, the shaft 26, a ring portion 104, a magnetic plate 34, and a wire supporting member 72. A lubricant 92 is continuously present in some gaps between the rotating body and the stationary body.

The housing 102, the shaft 26, the ring portion 104, a shaft encircling portion 30 forming the hub 28, and the lubricant 92 form a fluid dynamic bearing 48.

(Hub)

The hub 28 is formed in a predetermined shape like a substantially cup shape around a rotation axis R as viewed from the top. The hub 28 is formed by, for example, cutting and machining or pressing a ferrous material with a soft magnetism like SUS 430 of stainless-steel. In order to suppress a peeling from the surface, a surface layer forming process like electroless nickel plating may be applied to the hub 28. The hub 28 includes the shaft encircling portion 30 that encircles the shaft 26, a hub protrusion 28g that is provided outwardly in the radial direction relative to the shaft encircling portion 30, and to be engaged with the center hole of the magnetic recording disk 8, and, a mount portion 28h provided outwardly in the radial direction relative to the hub protrusion 28g. An outer circumference 28d of the hub protrusion 28g includes an electromechanical machined surface having undergone electromechanical machining.

(Clamper)

The magnetic recording disk 8 is to be mounted on a disk mount face 28a that is the upper face of the mount portion 28h. The magnetic recording disk 8 is held between the clamper 36 and the mount portion 28h, thereby being fastened to the hub 28. The clamper 36 applies downward force in the axial direction to the upper face of the magnetic recording disk 8 to cause the magnetic recording disk 8 to be in contact with the disk mount face 28a in a pressed manner against it. The clamper 36 is engaged with an outer circumference 28d of the hub protrusion 28g. The clamper 36 and the outer circumference 28d of the hub protrusion 28g can be joined together by mechanical joining techniques, such as screwing, caulking, and press-fitting.

(Magnet)

The magnet 32 is formed in a cylindrical shape around the rotation axis R as viewed from the top, and bonded and fastened to a cylindrical inner circumference of the hub 28 corresponding to the internal cylindrical face thereof. The magnet 32 is formed of, for example, a neodymium-based rare-earth magnetic material. The magnet 32 may be formed of other materials like a ferrite magnetic material. In this embodiment, the magnet 32 has, for example, 12 driving polarities in the circumferential direction thereof (a tangent line direction of a vertical circle to the rotation axis R and around it). The magnet 32 faces, for example, nine salient poles of the stator core 40 in the radial direction (i.e., a direction orthogonal to the rotation axis R).

(Stator Core)

The stator core 40 includes an annular part, and the nine salient poles extending therefrom outwardly in the radial direction, and is fixed on an upper-face-4d side of the base 4. The stator core 40 is formed by, for example, laminating six thin magnetic steel sheets each having a thickness of 0.2 mm, and caulking and integrating those sheets together. A surface coating, such as electrodeposition coating or powder coating, is applied to the surface of the stator core 40. The coil 42 is wound around each salient pole of the stator core 40. When three-phase substantially sinusoidal drive currents are caused to flow through the respective coils, drive magnetic fluxes are generated along the respective salient poles.

(Base Protrusion)

The base 4 includes an annular base protrusion 4e around the rotation axis R of the rotating body. The base protrusion 4e protrudes upwardly so as to encircle the housing 102. When the annular center hole of the annular part of the stator core 40 is engaged with an outer circumference of the base protrusion 4e, the stator core 40 is fixed to the base 4. In particular, the annular part of the stator core 40 is bonded and fixed to the base protrusion 4e by press-fitting or loose fitting.

(Bearing Hole)

The base 4 is provided with a bearing hole 4k around the rotation axis R. The bearing hole 4k is encircled by the base protrusion 4e, and passes all the way through the base 4. The bearing hole 4k may be a non through-hole. A base annular recess 58 concaving downwardly in the axial direction is provided in a middle area between the base protrusion 4e and the bearing hole 4k in the radial direction. A housing projection 60 to be discussed later enters the base annular recess 58. An annular projection 62 protruding upwardly in the axial direction is provided at the inner-circumference side of the base annular recess 58. The projection 62 enters a space in the radial direction between a first base-side encircling portion 112 to be discussed later and the housing projection 60. A female screw 68 is provided in the lower portion of the inner circumference of the bearing hole 4k.

(Insulation Sheet)

An annular insulation sheet 46 is provided on a portion of the upper face 4d of the base 4 corresponding to the coils 42. The insulation sheet 46 is formed of a resin like PET, and is fixed to the base 4 by, for example, bonding.

(Magnetic Plate)

The magnetic plate 34 in an annular shape as viewed from the top is provided on a portion of the upper face 4d of the base 4 corresponding to the magnet 32. The magnetic plate 34 is formed of a magnetic material, such as a ferrous material like a silicon steel sheet or a rolled steel sheet, or other magnetic materials, and attracts the magnet 32 magnetically. As a result, the rotating body including the magnet 32 is attracted toward the stationary body including the magnetic plate 34. A distance from the internal portion of the magnetic plate 34 to the rotation axis R is larger than a distance from the inner circumference of the magnet 32 to the rotation axis R. A distance from the external portion of the magnetic plate 34 to the rotation axis R is larger than a distance from the outer circumference of the magnet 32 to the rotation axis R.

The stationary body includes a wire hole 70 passing all the way through the base 4 from the upper face 4d to the lower face, a wire supporting member 72 fixed to the wire hole 70, and a drawn electrode 74 supported by the wire supporting member 72. The wire hole 70 includes multiple annular steps formed circularly as viewed from the top. The wire supporting member 72 is a hollow cylinder, and is formed by, as an example, plastic molding of an insulation material like a resin. External steps corresponding to the annular steps of the wire hole 70 are formed on the outer circumference of the wire supporting member 72. The wire supporting member 72 has the outer circumference engaged with the wire hole 70, and is fixed thereto by, for example, bonding. A drawn wire 44 of the coil 42 is led to the lower face of the base 4 through the hollow of the wire supporting member 72, and is electrically connected with a terminal of a conductor pattern 80 of a wiring member 76 by, for example, soldering. The hollow of the wire supporting member 72 is filled with a sealer 82 so as to suppress a leak-in and leak-out.

(Housing)

Next, an explanation will be given of the fluid dynamic bearing 48.

The housing 102 forms apart of the external portion of the fluid dynamic bearing 48.

The housing 102 includes a housing bottom 110, a support protrusion 108, the first base-side encircling portion 112, a second base-side encircling portion 122, the housing projection 60, a cover portion 124, and a core contacting portion 126, all being formed in an annular shape as viewed from the top.

The housing bottom 110 is formed in a flat disk shape and spreads in the radial direction. The support protrusion 108 is fixed to the inner circumference thereof and extends like a bar along the rotation axis R. The housing 102 forms, together with the shaft 26, an annular recess where the lower end of the shaft encircling portion 30 enters. The first base-side encircling portion 112 is a hollow cylindrical portion extending upwardly in the axial direction, and is fixed to the outer circumference of the housing bottom 110. The second base-side encircling portion 122 is a hollow cylindrical portion extending upwardly in the axial direction, and is provided at a location outwardly in the radial direction relative to the first base-side encircling portion 112, and above the first bas-side encircling portion 112 in the axial direction. The housing projection 60 extends downwardly in the axial direction, and as an example, fixed to the second base-side encircling portion 122. The housing projection 60 enters the base annular recess 58 in the axial direction. The cover portion 124 is fixed to the second base-side encircling portion 122 so as to cover the upper end of the base protrusion 4e.

The core contacting portion 126 extends downwardly in the axial direction from the cover portion 124 so as to contact the upper face of the annular part of the stator core 40. As a result, the annular part of the stator core 40 is held between the base 4 and the core contacting portion 126 in the axial direction, and is fixed therebetween. The upper end portion of the base protrusion 4e enters a space between the core contacting portion 126 and the second base-side encircling portion 122 in the axial direction.

(Male Screw)

A male screw to be engaged with a female screw provided in the base 4 is provided in the outer circumference of the housing 102. A bond as a sealant is present between the male screw and the female screw. In this embodiment, as an example, a male screw 66 is formed at a portion near the lower end of the outer circumference of the first base-side encircling portion 112. The male screw 66 is engaged with a female screw 68 provided in the inner circumference of the bearing hole 4k. A sealant 94 is present between the male screw 66 and the female screw 68. The male screw may be provided in the outer circumference of the second base-side encircling portion 122, and the female screw may be provided in the inner circumference of the base protrusion 4e.

As an example, the housing 102 has the housing bottom 110, the support protrusion 108, the first base-side encircling portion 112, the second base-side encircling portion 122, the housing projection 60, the cover portion 124, and the core contacting portion 126 formed integrally with each other. Any one of the components of the housing 102 may be separately formed, and then joined with the other components. The housing 102 is formed by machining, including cutting and pressing, of a metal like SUS 430 of stainless-steel, or a copper alloy. The housing 102 may include a portion to which a surface process like electroless nickel plating is applied. The housing 102 may include a portion formed by plastic molding of a resin material.

(Sealant)

The sealant 94 is present in a predetermined area between the fluid dynamic bearing 48 and the base 4. In this embodiment, the sealant 94 is applied between the outer circumference of the first base-side encircling portion 112, the outer circumference and a part of lower end face of the second base-side encircling portion 122, the inner circumference and lower end face of the housing projection 60, the lower end face of the cover portion 124, the inner circumference of the core contacting portion 126, and respective opposing faces.

An example sealant 94 is an epoxy-based or acryl-based bond. Different kinds of sealants 94 may be applied to respective sealed faces. In this embodiment, the common sealant 94 is continuously applied to the continuous sealed faces.

The shaft-fastening-screw hole 152 that is a non-through hole is formed in an upper end face 108b of the support protrusion 108 along the rotation axis R. The shaft fastening screw 6 enters the shaft-fastening-screw hole 152, and is engaged therewith by screwing. In order to enhance the joining strength, both screwing and bonding may be applied simultaneously. An explanation will now be given of a positional relationship among the shaft 26, the support protrusion 108, and the shaft fastening screw 6. The support protrusion 108 is held between the shaft 26 and the shaft fastening screw 6 in the radial direction, or is present between the shaft 26 and the shaft fastening screw 6. The shaft fastening screw 6 does not contact the shaft 26, but is indirectly fixed to the shaft 26.

(Shaft)

The shaft 26 extends along the rotation axis R of the hub 28. In the axial direction, the area where the shaft-fastening-screw hole 152 is formed extends beyond areas where first radial dynamic pressure generating grooves 50 and second radial dynamic pressure generating grooves 52 to be discussed later are formed. The shaft 26 includes a body 26f which runs along the rotation axis R and which encircles the support protrusion 108, and a flange 26g extending outwardly in the radial direction from the upper end portion of the body 26f. The support protrusion 108 is fixed to a support hole 26d by a combination of press-fitting and bonding.

(Ring Portion)

The ring 104 encircles the flange 26g, and is fixed to an outer circumference of the flange 26g. The ring 104 is fixed to the flange 26g by a combination of press-fitting and bonding. A bond between the ring 104 and the flange 26g also serves as a sealant that seals a clearance between the ring 104 and the flange 26g to suppress a leak-out of the lubricant 92.

The shaft encircling portion 30 encircles the body 26f. The lubricant 92 is applied between the shaft encircling portion 30 and the body 26f.

The shaft encircling portion 30 is held between the flange 26g, the ring portion 104 and the housing 102 in the axial direction (i.e., a parallel direction to the rotation axis R). The lubricant 92 is applied between the shaft encircling portion 30 and the ring portion 104, between the shaft encircling portion 30 and the flange 26g, and, between the shaft encircling portion 30 and the housing 102, respectively. The shaft encircling portion 30 includes a flange opposing face 28l which is a surface in a disk shape having a normal line substantially parallel with the rotation axis R. A lower face 28m of the shaft encircling portion 30 and an upper face 110b of the housing bottom 110 face with each other with a gap in the axial direction, and such a gap is filled with the lubricant 92.

(Tapered Space)

A tapered space that gradually becomes widespread between the shaft body and the bearing body toward the area where the gas is present from the area where the lubricant is applied is provided between the stationary body and the rotating body. The tapered space has a gas-liquid interface of the lubricant in the halfway thereof so as to hold the lubricant. The tapered space serves as a capillary seal that suppresses a leak-out of the lubricant by a capillary phenomenon. In particular, in this embodiment, a first tapered space 114 and a second tapered space 118 are provided. The tapered space may be referred to as a tapered seal.

(First Tapered Space)

The first base-side encircling portion 112 encircles the lower part of the shaft encircling portion 30. The first tapered space 114 that gradually becomes widespread toward the upper space between the inner circumference of the first base-side encircling portion 112 and the lower outer circumference of the shaft encircling portion 30 is formed between the first base-side encircling portion 112 and the shaft encircling portion 30. The first tapered space 114 holds the lubricant 92. The first tapered space 114 contacts, in the halfway thereof, a first gas-liquid interface 116 of the lubricant 92.

(Ring Encircling Portion)

The rotating body includes a ring encircling portion 38 that encircles at least a part of the ring portion 104 with a gap. The ring encircling portion 38 is formed in an annular shape around the rotation axis R as viewed from the top. In this embodiment, the ring encircling portion 38 is formed integrally with the hub 28, but maybe formed separately from the hub 28 and then joined with each other.

(Encircling-portion Recess)

An annular encircling-portion recess 154 around the rotation axis R is formed in the upper face of the shaft encircling portion 30. The encircling-portion recess 154 is concaved downwardly. At least a part of the outer circumference of the ring portion 104 enters the encircling-portion recess 154. The inner circumference of the encircling-portion recess 154 is included in the inner circumference of the ring encircling portion 38.

(Second Tapered Space)

A gap between the inner circumference of the ring encircling portion 38 and the outer circumference of the ring portion 104 forms the second tapered space 118 that gradually becomes widespread toward the upper space. The second tapered space 118 includes a second gas-liquid interface 120 of the lubricant 92, and suppresses a leak-out of the lubricant 92 by a capillary phenomenon.

(Radial Dynamic Pressure Generating Groove)

Radial dynamic pressure generating grooves that generate, when the shaft body and the bearing body relatively rotate, radial dynamic pressure to the lubricant which is separating force in the radial direction in the gap between the shaft body and the bearing body are formed between the stationary body and the rotating body. In this embodiment, the radial dynamic pressure generating grooves include first radial dynamic pressure generating grooves 50 and second radial dynamic pressure generating grooves 52.

The first and second radial dynamic pressure generating grooves 50, 52 that generate dynamic pressure in the radial direction to the lubricant 92 when the hub 28 rotates relative to the shaft 26 are formed in an inner circumference 30b of the shaft encircling portion 30 in a manner apart from each other in the axial direction. The first and second radial dynamic pressure generating grooves 50, 52 are formed in a herringbone shape or in a spiral shape.

At least either one of the first radial dynamic pressure generating grooves 50 and the second radial dynamic pressure generating grooves 52 maybe formed in the outer circumference of the body 26f instead of the inner circumference 30b of the shaft encircling portion 30.

(Thrust Dynamic Pressure Generating Groove)

Thrust dynamic pressure generating grooves that generate, when the shaft body and the bearing body relatively rotate, thrust dynamic pressure to the lubricant which is separating force in the thrust direction in the gap between the shaft body and the bearing body are formed between the stationary body and the rotating body. In this embodiment, the thrust dynamic pressure generating grooves include first thrust dynamic pressure generating grooves 54 and second thrust dynamic pressure generating grooves 56.

(First Thrust Dynamic Pressure Generating Groove)

The first thrust dynamic pressure generating grooves 54 that generate dynamic pressure in the axial direction to the lubricant 92 when the hub 28 rotates relative to the shaft 26 are formed in a lower face 28m of the shaft encircling portion 30. The first thrust dynamic pressure generating grooves 54 are formed in a herringbone shape or in a spiral shape. The first thrust dynamic pressure generating grooves 54 may be formed in an upper face 110b of the housing bottom 110 instead of the lower face 28m of the shaft encircling portion 30.

(Second Thrust Dynamic Pressure Generating Groove)

The second thrust dynamic pressure generating grooves 56 that generate dynamic pressure in the axial direction to the lubricant 92 when the hub 28 rotates relative to the shaft 26 are formed in the flange opposing face 28l of the shaft encircling portion 30. The second thrust dynamic pressure generating grooves 56 are formed in a herringbone shape or in a spiral shape. The second thrust dynamic pressure generating grooves 56 may be formed in a lower face 26i of the flange 26g instead of the flange opposing face 28l of the shaft encircling portion 30.

When the rotating body rotates relative to the stationary body, the first and second radial dynamic pressure generating grooves 50, 52 and the first and second thrust dynamic pressure generating grooves 54, 56 respectively generate dynamic pressure to the lubricant 92. The rotating body is supported in the radial direction and in the axial direction by such dynamic pressure in a non-contact manner with the stationary body.

An explanation will be given of an example method of engraving the radial dynamic pressure generating grooves 50, 52 and the thrust dynamic pressure generating grooves 54, 56. The dynamic pressure generating grooves can be formed by, for example, a rolling method of pushing a process tool against a groove formed part 30c while applying large force, and of causing the surface of the groove formed part 30c to be plastically deformed to engrave the grooves, an etching method like electrochemical machining of causing the groove formed part 30c in a predetermined electrolytic solution to face a predetermined electrode, and applying a voltage therebetween to engrave the grooves, or an alternation cutting method of causing the tip of a cutting tool to be alternately driven by alternation drive means like a Piezo element to perform alternation cutting on the surface of the groove formed part 30c, thereby engraving the grooves.

The radial dynamic pressure generating grooves 50, 52 and the thrust dynamic pressure generating grooves 54, 56 may be all engraved by the same method, or may be engraved by different methods, respectively. In this embodiment, the first and second radial dynamic pressure generating grooves 50, 52 and the first and second thrust dynamic pressure generating grooves 54, 56 are engraved by the alternation cutting method.

The dynamic pressure generating grooves formed by the rolling method include a plastic deformation portion plastically processed, the dynamic pressure generating grooves formed by the etching method include an etched portion having undergone etching, and the dynamic pressure generating grooves formed by the alternation cutting method include a cut portion. In this embodiment, the radial dynamic pressure generating grooves 50, 52 and the thrust dynamic pressure generating grooves 54, 56 include respective cut portion having undergone cutting.

(Shaft Encircling Portion)

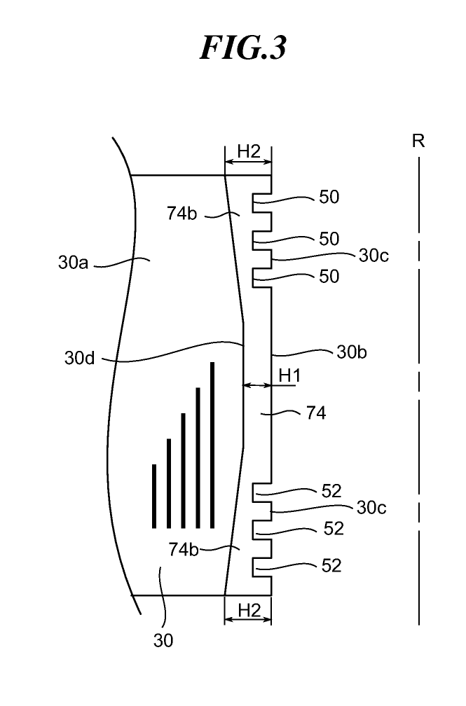

FIG. 3 is an enlarged cross-sectional view exemplarily illustrating an area near the inner circumference 30b of the shaft encircling portion 30 of the disk drive device 100 in FIG. 2, and the slant is emphasized to facilitate understanding to the present disclosure.

As to the shaft encircling portion 30, a base body 30a is formed by, for example, cutting a ferrous material like SUS 430 of stainless-steel or a metal like brass. In this embodiment, as an example, the shaft encircling portion 30 has a plating layer 74 formed on an inner circumference 30d of the base body 30a cut out from brass. The plating layer 74 is formed by, for example, electroless nickel plating. A primer plating layer may be formed by surface treatment like strike plating. When a difference in hardness between the plating layer 74 of the shaft encircling member 30 and the shaft 26 is small, a seizing may occur when those components contact with each other. Hence, the plating layer 74 of the shaft encircling portion 30 is subjected to a thermal process to increase the hardness thereof so as to be higher than that of the shaft 26.

(Plating Layer)

Next, an explanation will be given of the plating layer 74 on the inner circumference 30b of the shaft encircling portion 30. The shaft encircling portion 30 has a slanted plating layer 74b formed on the inner circumference 30b of the groove formed part 30c and gradually increasing the plating thickness toward the external side in the direction of the rotation axis R. That is, that shaft encircling portion 30 has the thickness of the plating layer 74 at the possibly contact area thicker than other portions.

When the slanted plating layer 74b is formed on the inner circumference 30b, the parallelism of the inner circumference 30b increases, and thus the shaft encircling portion 30 may have the shape accuracy of the radial dynamic pressure generating grooves deteriorated. In this embodiment, the shaft encircling portion 30 has the inner circumference 30d of the base body 30a without the slanted plating layer 74b gradually increasing the diameter toward the external side in the direction of the rotation axis R. As a result, the parallelism of the inner circumference 30b formed with the slanted plating layer 74b becomes small, and thus it becomes possible to suppress a reduction of the shape accuracy of the radial dynamic pressure generating grooves.

Next, an explanation will be given of an example method for forming the slanted plating layer 74b.

As to the plating layer 74, the pre-processed base body 30a of the shaft encircling portion 30 is soaked in an electroless nickel plating solution, and is swung in a predetermined direction. Hence, an oxidization-reduction reaction is caused in the solution, and nickel is precipitated on the surface of the base body 30a of the shaft encircling portion 30.

The inventors of the present disclosure keenly studied and found that the slanted plating layer 74b gradually becoming thick toward the external side in the direction of the rotation axis R can be formed on the inner circumference 30b by combining the following conditions:

(1) Swing the base body 30a of the shaft encircling portion 30 in the direction of the center axis thereof in the plating solution;

(2) When the stroke of the swing of the base body 30a of the shaft encircling member 30 is elongated and the cycle of the swing is shortened, the oxidization-reduction reaction becomes remarkable near the ends of the inner circumference 30b, and the plating thickness at the external side in the axial direction becomes relatively thick. When, for example, the cycle of the swing is 1.2 seconds, in comparison with a case in which the cycle is 2.5 seconds, a difference between the maximum plating thickness near the ends of the inner circumference 30b and the minimum plating thickness near the center becomes remarkably large;

(3) When the concentration of a stabilizer that suppresses the oxidization-reduction reaction in the plating solution is increased, the oxidization-reduction reaction near the ends of the inner circumference 30b is remarkably suppressed, and thus the plating thickness near the both ends of the inner circumference 30b becomes relatively thin;

(4) When the inner circumference 30b of the base body 30a of the shaft encircling portion 30 prior to the plating has a slant gradually increasing the diameter toward the external side in the axial direction, the plating thickness at the external side in the axial direction becomes relatively thick.

Based on those results, the condition to form the plating layer with a desired slant can be set through a test with parameters that are the swing direction, the swing stroke, the swing cycle, and the concentration of the stabilizer being as parameters.

In this embodiment, the groove formed part 30c of the shaft encircling portion 30 has a maximum plating thickness H2 of the slanted plating layer 74b at the external side in the axial direction larger than a minimum plating thickness H1 at the internal side in the axial direction. When a difference Hd between the maximum plating thickness H2 and the minimum plating thickness H1 is set to be equal to or greater than 0.1 μm, the effect of improving the wear resistance can be observed, and it is preferable to set the plating thickness difference Hd to be equal to or greater than 0.2 μm in consideration of a manufacturing error. According to the study by the inventors of the present disclosure, there is no particular practical problem in manufacturing of the shaft encircling portion 30 when the plating thickness difference Hd is equal to or less than 0.5 μm.

The above-explained method is merely an example, and the slanted plating layer 74b may be formed through other methods. In addition, it is confirmed that when the above-explained method is modified, a reverse-slanted plating layer having a plating thickness gradually becoming thin toward the external side in the direction of the rotation axis R can be formed on the groove formed part 30c of the inner circumference 30b of the shaft encircling portion 30.

(Dynamic Pressure Generating Groove)

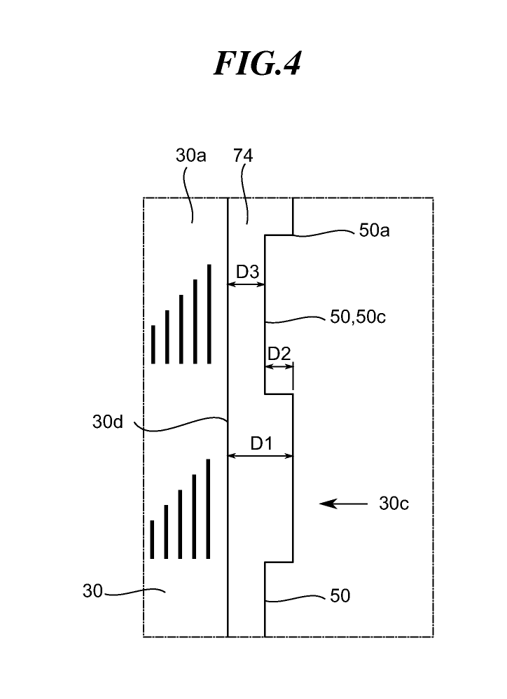

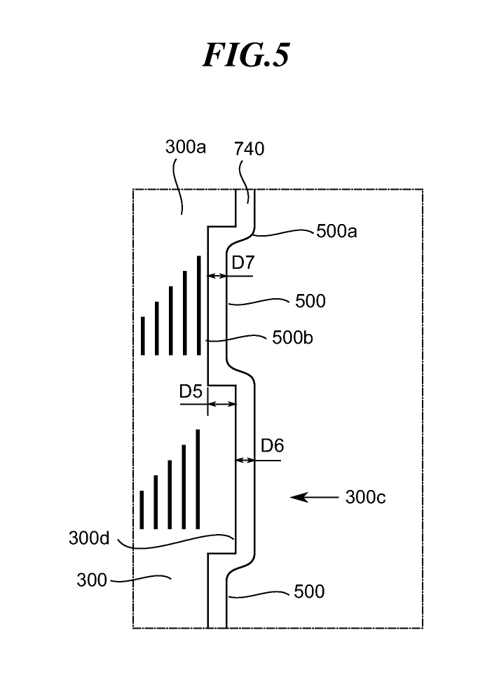

FIGS. 4 and 5 are enlarged cross-sectional views exemplarily illustrating an example structure of the groove formed part of the shaft encircling portion of the disk drive device. FIG. 4 illustrates an example case in which grooves are formed in the surface of the plating layer formed on the base body. In particular, the first radial dynamic pressure generating grooves 50 in FIG. 4 are engraved in the external surface of the plating layer 74 after the plating layer 74 is formed on the base body 30a. FIG. 5 is an enlarged cross-sectional view exemplarily illustrating another example structure corresponding to FIG. 4, and illustrates an example case in which the plating layer is formed after the grooves are engraved in the base body. In particular, radial dynamic pressure generating grooves 500 in FIG. 5 have grooves 500b engraved in a base body 300a of the shaft encircling portion 300 before a plating layer 740 is formed, and the plating layer 740 is formed thereafter.

Although the structure in FIG. 5 is also practical, this embodiment employs the structure in FIG. 4. Edges 50a of the first radial dynamic pressure generating grooves 50 in FIG. 4 are formed so as to be keener than those of edges 500a of the radial dynamic pressure generating grooves 500 in FIG. 5.

In the groove formed part 30c in FIG. 4, a minimum plating thickness D1 of a non-grooved part of the plating layer 74 after the first radial dynamic pressure generating grooves 50 are formed is larger than a maximum groove depth D2 of the first radial dynamic pressure generating grooves 50. When, for example, the maximum groove depth D2 of the dynamic pressure generating grooves is set to be 3 to 6 μm, the plating thickness D1 can be set to be equal to or greater than 7 μm. When the plating thickness D1 of the plating layer 74 becomes thick, a necessary work time for the plating process may increase, and thus the productivity may decrease. Hence, the plating thickness of the plating layer 74 can be set to be equal to or smaller than 30 μm. In this embodiment, the plating thickness D1 of the plating layer 74 is set to be within a range between equal to or greater than 8 μm and equal to or smaller than 20 μm. According to such a structure, the shaft encircling portion 30 can be manufactured within a practical work time.

The plating layer 74 after the first radial dynamic pressure generating grooves 50 are engraved may have a minimum plating thickness D3 larger than the maximum groove depth D2 of the first radial dynamic pressure generating grooves 50. For example, a plating thickness D can be 5 μm, while the maximum groove depth D2 can be 4 μm.

In this embodiment, the second radial dynamic pressure generating grooves 52 are engraved after the plating layer 74 is formed on the shaft encircling portion 30, and have the same features as those of the first radial dynamic pressure generating grooves 50.

In addition, the thrust dynamic pressure generating grooves 54, 56 are engraved after a plating layer is formed on the lower face 28m of the shaft encircling portion 30 and the flange opposing face 28l thereof, and have the same features as those of the radial dynamic pressure generating grooves 50.

(Cover Ring)

Returning to FIG. 2, the cover ring 12 is formed in an annular shape from a metal material like stainless-steel or a resin material, and covers the second tapered space 118. The cover ring 12 is fixed to, for example, the hub 28 of the rotating body or the flange 26g of the stationary body by caulking, press-fitting or a combination thereof. The cover ring 12 may include a lubricant capturer, such as a porous material like a sintered body, or a charcoal filter.

(Bypass Communication Hole)

The shaft encircling portion 30 is formed with a bypass communication hole 164 passing all the way through the shaft encircling portion 30 in the axial direction. The bypass communication hole 164 suppresses a pressure difference in areas where the lubricant 92 is applied even if, for example, the dynamic pressure becomes unbalanced, thereby maintaining the appropriate levels of the first gas-liquid interface 116 and the second gas-liquid interface 120.

An explanation will be given of an operation of the disk drive device 100 employing the above-explained structure. Three-phase drive currents are applied to the coils 42 through the conductor pattern 80 of the wiring member 76 to rotate the magnetic recording disk 8. When such drive currents flow through the respective coils 42, magnetic fluxes are generated along the nine salient poles. Those magnetic fluxes apply torque to the magnet 32, and thus the rotating body and the magnetic recording disk 8 engaged therewith rotate. While at the same time, when the voice coil motor 16 causes the swing arm 14 to swing, the recording/playing head goes out and comes in the swingable range over the magnetic recording disk 8. The recording/playing head converts magnetic data recorded in the magnetic recording disk 8 into electrical signals, and transmits the signals to a control board (unillustrated), or writes data transmitted in the form of electrical signals from the control board in the magnetic recording disk 8 as magnetic data.

Next, an explanation will be given of advantageous effects of this embodiment in detail.

According to the disk drive device 100 of this embodiment, the shaft encircling portion 30 includes the slanted plating layer 74b gradually increasing the plating thickness of the groove formed part 30b of the shaft encircling portion 30 toward the external side in the direction of the rotation axis. Hence, the plating layer near the ends of the inner circumference 30b of the bearing body can be made relatively thick. As a result, the wear resistance against a contact of the portion of the inner circumference 30b of the bearing body near the end thereof with the shaft can be improved.

According to the disk drive device 100 of this embodiment, the groove formed part 30c of the shaft encircling portion 30 has the slanted plating layer 74b which has the maximum plating thickness at the external sides in the direction of the rotation axis thicker than the minimum plating thickness at the internal side in the direction of the rotation axis within a range from 0.1 μm to 0.5 μm. Hence, the wear resistance can be improved while suppressing a reduction of the productivity of the shaft encircling portion 30.

According to the disk drive device 100 of this embodiment, the shaft encircling portion 30 has the inner circumference 30d of the base body 30a without the slanted plating layer 74b gradually increasing the diameter toward the external sides in the direction of the rotation axis. Therefore, a reduction of the parallelism of the inner circumference 30b can be suppressed.

According to the disk drive device 100 of this embodiment, the shaft encircling portion 30 has the dynamic pressure generating grooves engraved in the external surface side of the plating layer. Hence, a reduction of the shape accuracy of the edges of the dynamic pressure generating grooves can be suppressed, and dynamic pressure to be generated can be improved. Even if the plating layer is made thick, a reduction of the shape accuracy of the edges of the dynamic pressure generating grooves can be suppressed.

According to the disk drive device 100 of this embodiment, the plating layer 74 having the grooves of the shaft encircling portion 30 engraved therein has the minimum plating thickness D1 of the non-grooved part larger than the maximum groove depth D2. Therefore, even if the plating thickness becomes thin due to a manufacturing error, the surface of the base body 30a of the shaft encircling portion 30 can be prevented from being exposed at the bottom of the grooves.

According to the disk drive device 100 of this embodiment, the dynamic pressure generating grooves of the shaft encircling portion 30 include at least one of the plastic deformed portion having undergone plastic deformation, a cut portion having undergone cutting, and an etched portion having undergone etching. Therefore, the shape accuracy of the dynamic pressure generating grooves can be improved.

According to the disk drive device 100 of this embodiment, the plating layer 74 having the grooves of the shaft encircling portion 30 engraved therein has a higher surface hardness than the portion of the shaft 26 facing the plating layer 74. Hence, the durability of the plating layer 74 is improved, thereby reducing a possibility of seizing.

According to the disk drive device 100 of this embodiment, the plating layer 74 having the grooves of the shaft encircling portion 30 engraved therein has the minimum plating thickness D3 of the dynamic pressure generating grooves larger than the maximum groove depth D2 thereof. Therefore, the plating thickness of the plating layer 74 can be made thick entirely.

According to the disk drive device 100 of this embodiment, the plating layer 74 having the grooves of the shaft encircling portion 30 engraved therein has the maximum plating thickness D1 of the non-grooved part that is within a range from 8 μm and 20 μm. Therefore, a reduction of the productivity can be suppressed while improving the durability of the plating layer 74.

According to the disk drive device 100 of this embodiment, the plating layer 74 having the grooves of the shaft encircling portion 30 engraved therein has a primer plating layer formed on the surface of the base body 30a, enabling astable formation of an electroless nickel plating layer.

The structure of the disk drive device and the operation thereof according to this embodiment were explained above. However, the embodiment is merely an example, and permits various modifications of a combination of structural components, and such modifications should be within the scope of the present disclosure.

In the aforementioned embodiment, components explained as being formed by joining equal to or greater than two pieces initially formed separately may be initially formed integrally with each other in accordance with the specification of the product and the demand in manufacturing, and components explained as being formed integrally may be formed by joining equal to or greater than two pieces initially formed separately in accordance with the specification of the product and the demand in manufacturing. According to such a joining, for example, bonding, shrink fitting, welding can be applied in solo or a combination of equal to or greater than two such techniques are also applicable.

What is claimed is:

1. A rotating device comprising:
a shaft body including a portion extending in an axial direction; and
a bearing body which retains a part of the shaft body, is relatively rotatable to the shaft body, and is provided with a groove formed part having an inner circumference formed with a fluid dynamic pressure generating groove,
wherein the bearing body comprises, at the groove formed part, a slanted plating layer having a plating thickness gradually becoming thick toward an external side in the axial direction.

2. The rotating device according to claim 1, wherein a maximum plating thickness of the slanted plating layer at the external side in the axial direction is larger than a minimum plating thickness at an internal side in the axial direction within a range between equal to or greater than 0.1 μm and equal to or smaller than 0.5 μm.

3. The rotating device according to claim 1, wherein the bearing body has the groove formed part without the slanted plating layer gradually increasing a diameter toward the external side in the axial direction.

4. The rotating device according to claim 1, wherein the bearing body has the fluid dynamic pressure generating groove engraved in an external surface side of the slanted plating layer.

5. The rotating device according to claim 1, wherein:
the portion extending in the axial direction comprises an external body, and an internal body retained in a hole extending in the external body in the axial direction; and
the slanted plating layer encircles the external body.

6. The rotating device according to claim 1, wherein:
the shaft body comprises a flange extending outwardly in a radial direction from a first-end side part of the portion extending in the axial direction, and a spread portion spreading outwardly in the radial direction from a second-end side part of the portion extending in the axial direction: and
the slanted plating layer is located between the flange and the spread portion in the axial direction.

7. The rotating device according to claim 1, wherein:
the shaft body comprises a ring portion supported by a first-end side part of the portion extending in the axial direction in a fixed manner, and including a part encircling the first-end side part; and
the slanted plating layer at least partially overlaps an area of the ring portion in the axial direction.

8. The rotating device according to claim 1, wherein:
the bearing body further comprises a first-thrust-dynamic-pressure-generating-groove formed area and a second-thrust-dynamic-pressure-generating-groove formed area; and
the slanted plating layer is located between the first-thrust-dynamic-pressure-generating-groove formed area and the
second-thrust-dynamic-pressure-generating-groove formed area in the axial direction.

9. A rotating device comprising:
a shaft body including a portion extending in an axial direction; and
a bearing body which retains a part of the shaft body, is relatively rotatable to the shaft body, and is provided with a groove formed part having an inner circumference formed with a fluid dynamic pressure generating groove,
wherein the bearing body comprises, at the groove formed part, a slanted plating layer having a plating thickness gradually becoming thick toward an internal side in the axial direction.

10. The rotating device according to claim 9, wherein a maximum plating thickness of the slanted plating layer at the internal side in the axial direction is larger than a minimum plating thickness at an external side in the axial direction within a range between equal to or greater than 0.1 μm and equal to or smaller than 0.5 μm.

11. The rotating device according to claim 9, wherein the bearing body has the groove formed part without the slanted plating layer gradually increasing a diameter toward the internal side in the axial direction.

12. The rotating device according to claim 9, wherein the bearing body has the fluid dynamic pressure generating groove engraved in an external surface side of the slanted plating layer.

13. The rotating device according to claim 9, wherein:
the portion extending in the axial direction comprises an external body, and an internal body retained in a hole extending in the external body in the axial direction; and
the slanted plating layer encircles the external body.

14. The rotating device according to claim 9, wherein:
the shaft body comprises a flange extending outwardly in a radial direction from a first-end side part of the portion extending in the axial direction, and a spread portion spreading outwardly in the radial direction from a second-end side part of the portion extending in the axial direction: and
the slanted plating layer is located between the flange and the spread portion in the axial direction.

15. The rotating device according to claim 9, wherein:
the shaft body comprises a ring portion supported by a first-end side part of the portion extending in the axial direction in a fixed manner, and including a part encircling the first-end side part; and
the slanted plating layer at least partially overlaps an area of the ring portion in the axial direction.

16. The rotating device according to claim 9, wherein:
the bearing body further comprises a first-thrust-dynamic-pressure-generating-groove formed area and a second-thrust-dynamic-pressure-generating-groove formed area; and
the slanted plating layer is located between the first-thrust-dynamic-pressure-generating-groove formed area and the
second-thrust-dynamic-pressure-generating-groove formed area in the axial direction.

17. A rotating device comprising:
a shaft body including a portion extending in an axial direction; and
a bearing body which retains a part of the shaft body, is relatively rotatable to the shaft body, and is provided with a groove formed part having an inner circumference formed with a fluid dynamic pressure generating groove,
wherein:
the bearing body comprises, at the groove formed part, a slanted plating layer having a plating thickness gradually becoming thick toward a first direction in the axial direction;
a difference between a maximum plating thickness of the slanted plating layer and a minimum plating thickness thereof is within a range between equal to or greater than 0.1 μm and equal to or smaller than 0.5 μm; and
the fluid dynamic pressure generating groove is engraved in an external surface side of the slanted plating layer.

18. The rotating device according to claim 17, wherein the bearing body has the groove formed part without the slanted plating layer gradually increasing a diameter toward an opposite direction to the first direction.

19. The rotating device according to claim 17, wherein :
the shaft body comprises a flange extending outwardly in a radial direction from a first-end side part of the portion extending in the axial direction, and a spread portion spreading outwardly in the radial direction from a second-end side part of the portion extending in the axial direction: and
the slanted plating layer is located between the flange and the spread portion in the axial direction.

20. The rotating device according to claim 17, wherein:
the bearing body further comprises a first-thrust-dynamic-pressure-generating-groove formed area and a
second-thrust-dynamic-pressure-generating-groove formed area; and
the slanted plating layer is located between the first-thrust-dynamic-pressure-generating-groove formed area and the
second-thrust-dynamic-pressure-generating-groove formed area in the axial direction.
